(19) United States
(12) Patent Application Publication
(10) Pub. No.: US 2005/0122318 A1
(43) Pub. Date: Jun. 9, 2005

(54) Data processing device

(75) Inventors: Yojiro Tonouchi, Kanagawa (JP); Kei Sakamoto, Tokyo (JP); Tomohiro Hanyu, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 10/986,098

(22) Filed: Nov. 12, 2004

(30) Foreign Application Priority Data
Nov. 14, 2003 (JP) 2003-385340

(51) Int. Cl. G09G 5/00

(52) U.S. Cl. 345/179

(57) ABSTRACT

A data processing device includes plural input modes which is capable of, for instance, automatically determining whether the device is in a notebook mode or a tablet mode, thereby enabling a user to use the data processing device by use of an interface suitable for the mode without performing any particular operation for choosing the interface. The data processing device includes a display which is integrally configured with a tablet, a mode determination section which determines an input mode on basis of the tablet, and a mode controller which switches a user interface on basis of the result of determination of the mode determination section. When configured as described above, the convertible data processing device can automatically determine whether the device is in a notebook mode or a tablet mode, and provide a user with an interface suitable for the mode. Accordingly, comfortable operability can be realized.

### CROSS-REFERENCE TO RELATED APPLICATIONS

This application is based upon and claims the benefit of priority from the prior Japanese Patent Applications No. 2003-385340 filed on Nov. 14, 2003; the entire contents of which are incorporated herein by reference.

### BACKGROUND OF THE INVENTION

1. Field of the Invention

The present invention relates to a data processing device, such as a computer, a personal digital assistant, or a word processor, having two or more input modes including a mode where a keyboard or a touch-pad is used while the device is in an open state (notebook mode) as is the case with a normal notebook PC, and a mode where a pen is used while the device is in a collapsed state (tablet mode).

2. Description of the Related Art

Conventional data processing devices having a plurality of input modes has two modes, e.g., a mode (a notebook mode) where input is effected by a keyboard and a mouse and a mode (a tablet mode) where input is effected by handwriting with a pen, or the like. In a data processing device having a plurality of input modes, the type of input means to be employed and direction thereof during use, and the like, change greatly from one mode to another. For instance, in the notebook mode, there are many situations where a keyboard and a touch-pad are used from the front as in the case of a normal notebook PC. In contrast, in the tablet mode, a device is supposed to be used on a device from desired directions thereof.

As described above, in consideration of the fact that the direction—in which the user uses the data processing device—differs in many cases between, e.g., the notebook mode and the tablet mode, the user switches the direction of a screen display or that of input means in accordance with directions assigned respectively to the notebook mode and the tablet mode, in a data processing device having a plurality of input modes (see, e.g., JP2003-296033 (kokai) ([0019], FIG. 4)).

A data processing device typified by a notebook PC assumes usage by use of a keyboard and a mouse. Accordingly, many data processing devices having a plurality of input modes adopt a user interface for a notebook mode, which users often find to be inconvenient, especially in a tablet mode.

For this reason, in many data processing devices having a plurality of input modes, input means as well as the direction of a screen display used by the user often change between, e.g., the notebook mode and the tablet mode. Accordingly, the user himself/herself switches the mode. Furthermore, in addition to the direction of the screen display, there also arises a problem of the user feeling inconvenience when a single input means is employed for both the notebook mode and the tablet mode.

### SUMMARY OF THE INVENTION

The present invention has been conceived in view of the above circumstances and provides a data processing device having a plurality of input modes which is capable of, for instance, automatically determining whether the device is in a notebook mode or a tablet mode, thereby enabling a user to use an interface suitable for the current mode.

According to first aspect of the present invention, a data processing device includes a display integrally configured with a tablet, a mode determination unit to determine whether or not a current mode is an input mode employing the tablet, and a mode controller to switch a user interface on basis of a result of determination of the mode determination unit.

According to second aspect of the present invention, a data processing device includes a display integrally configured with a tablet, an input unit, an input controller to control input information input by the input unit, a mode determination unit to determine whether or not a current mode is an input mode employing the tablet, and a mode controller to switch whether or not to accept the input information in accordance with a result of determination of the mode determination unit.

According to third aspect of the present invention, a data processing device includes a display integrally configured with a tablet, an input unit, a mode determination unit to determine whether or not a current mode is an input mode employing the tablet, and a mode controller to switch an operation mode to be performed by way of the input unit in accordance with a result of determination of the mode determination unit.

According to fourth aspect of the present invention, a data processing device includes a display integrally configured with a tablet, an input unit, a mode determination unit to determine whether or not a current mode is an input mode employing the tablet, and a mode controller to switch a mode of displaying information input by way of the input unit in accordance with a result of determination of the mode determination unit.

According to fifth aspect of the present invention, a data processing device includes a display integrally configured with a tablet, a mode determination unit to determine whether or not a current mode is an input mode employing the tablet, and a mode controller to switch software to be operated on basis of a result of determination of the mode determination unit.

According to sixth aspect of the present invention, a data processing device includes a display integrally configured with a tablet, an authenticator to logon, a mode determination unit to determine whether or not a current mode is an input mode employing the tablet, and a mode controller to switch an authentication mode in accordance with a result of determination of the mode determination unit.

According to seventh aspect of the present invention, a portable device includes a display integrally configured with a input in a tablet mode, a input unit to input in a notebook mode, a mode determination unit to determine whether a current mode is the notebook mode or the tablet mode, and a mode controller to switch a user input interface on basis of a result of determination of the mode determination unit.

According to the present invention, in a data processing device having a plurality of input modes, an interface suitable for the current mode can be automatically provided to a user. Accordingly, operation efficiency of the user can be enhanced. Particularly, there is automatically performed switching to an appropriate interface in the tablet mode without causing the user to perform a special operation, and hence the user can operate the data processing device with comfort.

### BRIEF DESCRIPTION OF THE DRAWINGS

FIG. 1 is a block diagram showing a configuration of a data processing apparatus according to an embodiment of the present invention;

FIGS. 2A and 2B are diagrams showing a notebook mode and a tablet mode;

FIG. 3 is a diagram showing an example mode determination;

FIGS. 4A to 4D are diagrams showing switching between modes;

FIG. 5 is a diagram showing an example of processing pertaining to switching between a notebook mode and a tablet mode; and

FIGS. 6A to 6C are diagrams showing examples of trails displayed on screens.

### DETAILED DESCRIPTION OF THE INVENTION

Hereinafter, an embodiment of the invention will be described by reference to the drawings.

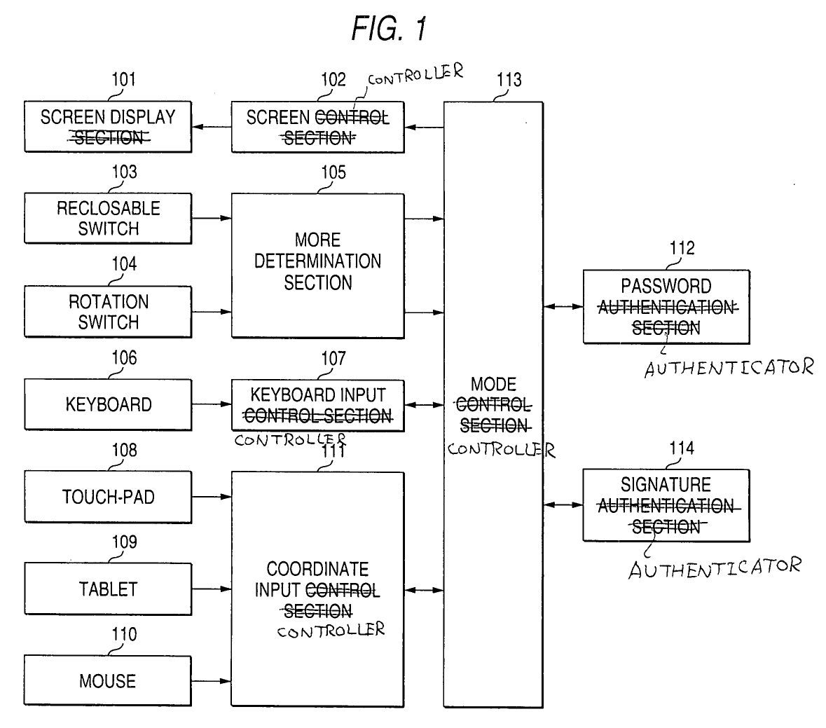

FIG. 1 is a block diagram showing a data processing device of the present invention. The data processing device shown in FIG. 1 includes a screen display 101, a screen controller 102, a reclosable switch 103, a rotation switch 104, a mode determination section 105, a keyboard 106, a keyboard input controller 107, a to touch-pad 108, a tablet 109, a mouse 110, a coordinate input controller 111, a password authenticator 112, a mode controller 113, and a signature authenticator 114.

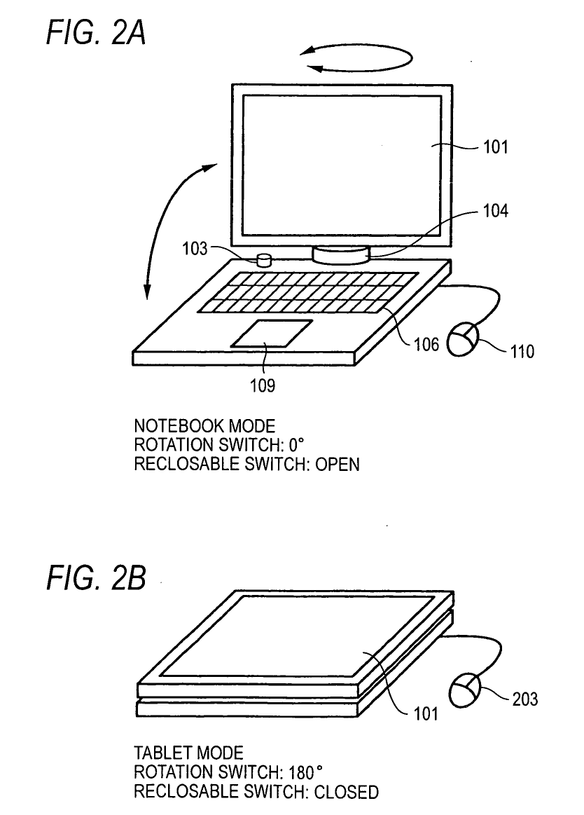

FIG. 2A shows a notebook mode of a data processing device, such as a convertible notebook PC, and FIG. 2B shows a tablet mode thereof.

The reclosable switch 103 is a switch for detecting an open state and a collapsed state of, e.g., a convertible data processing device. The rotation switch 104 is a switch for detecting a rotation in a direction different from that opening/closing action of the display screen of the convertible data processing device. The screen controller 102 controls on-screen displayed components, such as a mouse cursor, a button, a menu, and a scroll bar. The keyboard input controller 107 accepts input from the keyboard 106, however, when the mode controller 113 determines that the input from the keyboard 106 cannot be accepted, the keyboard input controller 107 does not output the input from the keyboard 106. The coordinate input controller 111 accepts inputs from the mouse 110, the tablet 109, and the touch-pad 108. However, when the mode controller 113 determines that input from an arbitrary one of the mouse 110, the tablet 109, and the touch-pad 108 is unacceptable, the coordinate input controller 111 does not output that input.

The signature authenticator 114 checks similarity between a signature input at the time of logon and a signature which has been registered in advance, by use of a signature collation processing technique (see, e.g., “Study on Identification of Signature by Tree-Matching,” Shingaku-Giho, D-II, Vol. J75-D-II, No. 1, pp. 31-38, 1992), and when the signature is authenticated, the signature authenticator 114 permits the logon. Meanwhile, the password authenticator checks whether a password (a character string) coincides with the password which has been registered in advance, when the passwords coincide, the password authenticator 114 permits the logon.

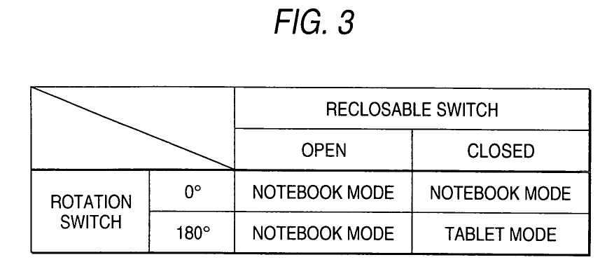

As shown in FIG. 3, the mode determination section 105 determines whether or not the device is in the tablet mode, on the basis of the states of the reclosable switch 103 and the rotation switch 104. In the illustrated example, the device is determined to be in the tablet mode when the reclosable switch is open, and the rotation switch 104 is at 180°.

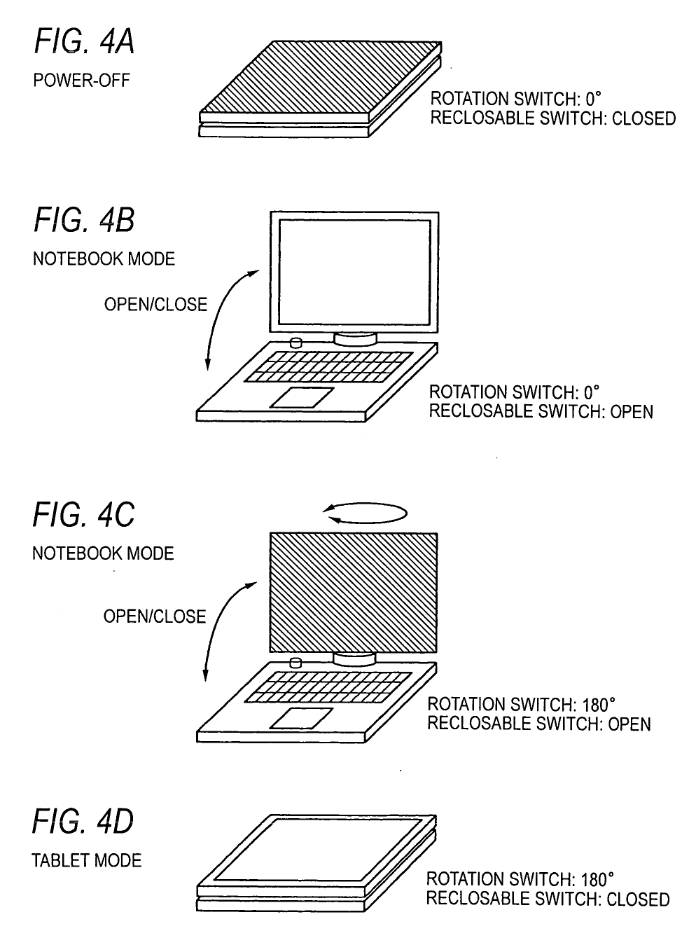

FIGS. 4A to 4D show mode switching from a power-off mode through the tablet mode. FIG. 4A shows a power-off state where the screen display 101 is folded so as to face the keyboard 106 and the touch-pad 108. When the screen display 101 is opened, a view such as that shown in FIG. 4B is acquired, so that the device enters the notebook mode. When the display 101 is rotated about the reclosable section by 180° (FIG. 4C), and the display 101 is closed such that the surface opposite the screen faces the keyboard 106 and the touch-pad 108, the device enters the tablet mode as shown in FIG. 4D.

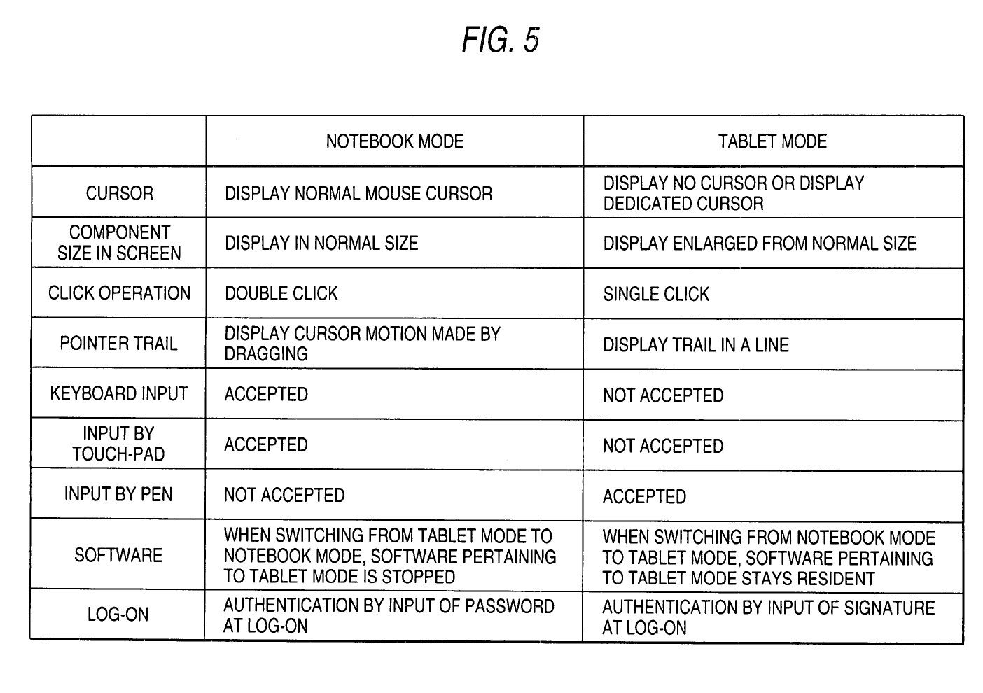

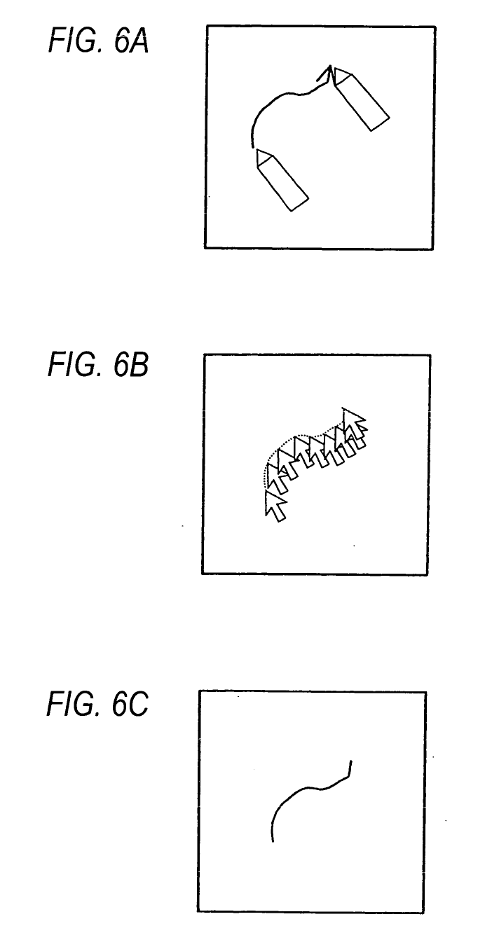

FIG. 5 shows an example of processing pertaining to switching between the notebook mode and the tablet mode. With regard to a cursor displayed on a screen, in the notebook mode a normal mouse cursor is displayed. In contrast, in the tablet mode, the cursor is not displayed, so that the user will not be distracted with parallax or time delay, or a dedicated cursor different from that of the normal cursor is displayed, for instance, as shown in FIG. 6A. Displayed components, such as a mouse cursor, a button, a menu, and a scroll bar, in the tablet mode are displayed in a magnified manner as compared to those in the normal notebook mode. With regard to operation modes typified in click operation, in the notebook mode a double click is adopted. In contrast, in the tablet mode, a single click is chiefly adopted, because input is mainly performed by a pen on the tablet.

Furthermore, with regard to display of a pointer trail on the screen, in the notebook mode where input is mainly performed by the mouse 110, cursor motion caused by dragging of the mouse 110 is displayed as shown in FIG. 6B. In the tablet mode, a trail traced by pen input is displayed in a form of a stroke as shown in FIG. 6C. In the notebook mode, input by the keyboard 106 and input by the touch-pad 108 are accepted. However, in the tablet mode, input by the keyboard 108 and input by the touch-pad 108 are not accepted. Meanwhile, in the notebook mode, input by a pen (tablet) is not accepted, whereas such input is accepted in the tablet mode.

Furthermore, at the time of switching from the notebook mode to the tablet mode, software pertaining to the tablet stays resident. In contrast, at the time of switching to the notebook mode, the software pertaining to the tablet is stopped. With regard to logon to the data processing device, in the notebook mode, authentication is processed with use of a password, in the tablet mode, authentication is processed by input of a signature.

As described above, in the notebook mode, input and operations are mainly performed by the keyboard 106, the touch-pad 108, and the mouse 110. In the tablet mode, input and operations are mainly performed by a pen. Accordingly, upon acceptance of the result determined by the mode determination section 105, the mode controller 113 switches a user interface to a suitable one for the mode so as to provide the user with a suitable interface for the operation method.

By virtue of the above configuration, operation efficiency of the user can be enhanced. Particularly, there is automatically performed switching to an appropriate interface in the tablet mode without causing the user to perform a special operation, and hence the user can operate the data processing device with comfort.

1. A data processing device comprising:
a display integrally configured with a tablet;
a mode determination unit to determine whether or not a current mode is an input mode employing the tablet; and
a mode controller to switch a user interface on basis of a result of determination of the mode determination unit.

2. The data processing device according to claim 1, wherein the mode determination unit makes a determination on basis of opening/closing and rotation of on the display.

3. The data processing device according to claim 1, wherein the mode controller changes a mouse cursor displayed on the display.

4. The data processing device according to claim 1, wherein the mode controller changes sizes of an item displayed on the display.

5. A data processing device comprising:
a display integrally configured with a tablet;
an input unit;
an input controller to control input information input by the input unit;
a mode determination unit to determine whether or not a current mode is an input mode employing the tablet; and
a mode controller to switch whether or not to accept the input information in accordance with a result of determination of the mode determination unit.

6. A data processing device comprising:
a display integrally configured with a tablet;
an input unit;
a mode determination unit to determine whether or not a current mode is an input mode employing the tablet; and
a mode controller to switch an operation mode to be performed by way of the input unit in accordance with a result of determination of the mode determination unit.

7. A data processing device comprising:
a display integrally configured with a tablet;
an input unit;
a mode determination unit to determine whether or not a current mode is an input mode employing the tablet; and
a mode controller to switch a mode of displaying information input by way of the input unit in accordance with a result of determination of the mode determination unit.

8. A data processing device comprising:
a display integrally configured with a tablet;
a mode determination unit to determine whether or not a current mode is an input mode employing the tablet; and
a mode controller to switch software to be operated on basis of a result of determination of the mode determination unit.

9. A data processing device comprising:
a display integrally configured with a tablet;
an authenticator to logon;
a mode determination unit to determine whether or not a current mode is an input mode employing the tablet; and
a mode controller to switch an authentication mode in accordance with a result of determination of the mode determination unit.

10. A portable device comprising:
a display integrally configured with a input in a tablet mode;
a input unit to input in a notebook mode;
a mode determination unit to determine whether a current mode is the notebook mode or the tablet mode; and
a mode controller to switch a user input interface on basis of a result of determination of the mode determination unit.

11. The portable device according to claim 10, wherein the mode determination unit makes a determination on basis of opening/closing and rotation of the display.

12. The portable device according to claim 10, further comprising:
a reclosable switch configured to detect an opening/closing of the display; and
a rotation switch configured to detect a rotation angle of the display, wherein
the mode determination unit makes a determination on basis of combination of the opening/closing and the rotation angle.

13. The portable device according to claim 10, wherein the mode controller changes a mouse cursor displayed on the display.

14. The portable device according to claim 10, wherein the mode controller changes sizes of an item displayed on the display.

15. The portable device according to claim 10, wherein the input unit is at least one of keyboard, touch-pad ,and mouse; and
the input in the tablet mode is inputted by handwriting with a pen.
